(19) United States
(12) Patent Application Publication
(10) Pub. No.: US 2013/0156114 A1
(43) Pub. Date: Jun. 20, 2013

(54) Data Movement Reduction In Video Compression Systems

(71) Applicant: Faramarz Azadegan, La Jolla, CA (US)

(72) Inventor: Faramarz Azadegan, La Jolla, CA (US)

(21) Appl. No.: 13/329,262

(22) Filed: Dec. 17, 2011

(51) Int. Cl. H04N 7/26

(52) U.S. Cl. 375/240.26; 375/E07.104

(57) ABSTRACT

A process for reducing data movement and thereby reducing the power consumption and reducing cycle requirements for video compression techniques is described. A process for improving data acquisition process for motion estimation when transitioning from one macroblock to next adjacent macroblock by selective replacement of motion estimation area is described. One process involves replacing a non-overlapped search area in one (left) region

belonging to one macroblock with the new search area in another (right) region belonging to the next adjacent macroblock. Another method involves replacing a non-overlapped search area in one (left) region with the new search area in another (right) region employing a cyclic memory structure. A third method in using the overlapped search areas for vertically adjacent regions is described. The processes involve improvements to MPEG-1, H.261, MPEG-2/H.262, MPEG-4, H.263, H.264/AVC, VP8, and VC-1 video coding standards and any other video compression technique employing a motion estimation technique.

### BACKGROUND OF THE INVENTION

1. Field of the Invention

The present invention relates generally to data compression in the field of video compression and pattern matching systems. This invention may be used for integration into digital signal processing (DSP) systems, application specific integrated systems (ASIC) and system on chip (SOC) and further to general software implementation. More particularly, the invention relates to a method for reducing the data movement in motion estimation technique and pattern matching technique. Motion estimation is an integral part of any video compression system, and pattern matching technique is an integral part of any video or image search system.

2. Description of the Related Art

The electronic transmission of video pictures, either analog or digital, has presented various problems of both transmission or storage quality, transmission or storage efficiency, transmission bandwidth or storage size in the art of video communication. In the context of digital video transmissions particularly, quality and, bandwidth or storage, and efficiency issues are frequently intertwined. Over the years, the most common solution to these issues has involved various types of video compression.

There are two components to video compression, spatial compression and temporal compression. Spatial compression strives to achieve a reduction in the information content of the video transmission by applying mathematical methods to reduce the redundancy of the contents of one video frame using the information only contained in that frame, thus, to reduce spatial redundancy. One of the most common mathematical methods for reducing spatial redundancy is discrete cosine transform (DCT), as used by the Joint Picture Experts Group (JPEG) standard for compression of still images. In addition, video signals, are frequently compressed by DCT or other block transform or filtering techniques, such as wavelet, to reduce spatial redundancy pursuant to the Motion-JPEG (M-JPEG) or JPEG-2000 standards.

In addition to spatial compression, temporal compression is used for video signals since video sequences have highly correlated consecutive frames which are exploited in temporal compression schemes. Video compression techniques frequently apply temporal compression for purposes of video compression, pursuant to the Motion Picture Experts Group (MPEG) standards. One of the fundamental elements of temporal compression involves the reduction of data rates, and a common method for reducing data rates in temporal compression is motion estimation in the encoder (transmitter) and motion compensation in the decoder (receiver). Motion estimation is a method of predicting one frame based upon an earlier transmitted frame. For example, in motion estimation, a predicted frame (P-frame) or bi-directionally predicted frame (B-frame) is compressed based on an earlier transmitted intra-coded frame (I-frame, that is, a frame that has only been only spatially coded) or an earlier transmitted predicted frame (P-frame, that is, a predicted frame that has been coded and transmitted). In this manner, using temporal compression, the P-frame or B-frame is coded based on the earlier I-frame or earlier P-frame. Thus, if there is little difference between the P-frame/B-frame and the previous I-frame/P-frame, motion estimation and motion compensation will result in a significant reduction of the data needed to represent the content of the video using temporal compression.

Various standards have been proposed for using both spatial and temporal compression for the purposes of video compression. The International Telecommunication Union (ITU), for example, has established the H.261, H.262, H.263, and H.264/AVC standards for the transmission of video for variety of networks. Similarly International Systems Organization (ISO) has established MPEG-1, MPEG-2, MPEG-4 for transmission or storage of video for variety of applications.

All of these standards focus on both spatial compression and temporal compression with the temporal compression providing major part of the compression. As a result, the attention to temporal compression is much higher than spatial compression.

The coding structure in all standard video compression systems described (MPEG-1, MPEG-2, MPEG-4, H.261, H.262, H.263, H.264) uses macroblocks, MB, for coding structure.

The MB in MPEG (MPEG-1, MPEG-2 MPEG-4) or ITU H.263 or H.264/AVC systems is of size 16×16 of luminance, which means they consist of 16 rows by 16 columns luminance, and the spatially corresponding 8×8 block sizes for two chrominance components U and V for 4:2:0 systems, where 4:2:0 indicates the sampling structure used for luminance and chrominance of signal. For 4:2:2 and 4:4:4 systems which contain higher chrominance resolution corresponding to higher sampling rates for the chrominance signals, the chrominance components are the spatially corresponding sizes of 16×8 and 16×16 respectively. In recent video compression systems such as H.264, this luminance part of macro block may be partitioned into smaller sizes of 4×4, 8×4, 4×8, 8×8, etc. with the appropriate corresponding sub-partitioning of chrominance blocks.

The compression system for said standards follow a strict coding structure in which it compresses MBs sequentially from left to right and top to bottom of each frame, starting at the top-left corner of the frame and ending at the right-bottom corner of the frame. More specifically, after a row of MBs are coded, the next vertically lower adjacent row of the MBs are coded from left to right. The general format of compression of each MB consists of block transform of original data for I-frame or residual/original data for P-frame and B-frame along with motion vectors for the MB of P-frame or B-frame. The motion vectors represent the offset between the target MB, that is the MB to be compressed, and the closest match in the previous frame or frames (for B-frame) which has already been compressed and transmitted. The block transform is followed by quantization and variable-length-coding (VLC) creating a bitstream representation for the MB. The bitstream for MBs are appended based on the said coding structure (left to right and top to bottom of the frame) to create a bitstream representation for the frame. Each of the said resulting bitstreams for the frames is sequentially appended to create the bitstream for the entire video.

In other proposed data movement reduction techniques in motion estimation in U.S. Pat. No. 7,496,736 to Haghighi, this coding sequence (top-left to bottom-right) is not followed resulting in major technical challenges to provide a video compression system. This proposed system cannot be used by the current standards without significant changes to the standards or the sequence in which compression MBs are conducted.

The motion estimation technique used to accomplish temporal compression generally uses a so-called block matching algorithm using only the 16×16 luminance of the MB. In the said block matching algorithm, an MB from the current frame to be encoded, called the target MB is selected and a search is conducted within the previously coded frame to find the best match to the said target MB. This procedure is referred to as motion estimation technique. In recent video compression systems such as H.264, this luminance part of macro block may be partitioned into smaller sizes of 4×4, 8×4, 4×8, 8×8, etc. for motion estimation with the appropriate corresponding sub-partitioning of chrominance blocks for the rest of the compression process. In the search mechanism for H.264, any of these smaller size blocks may be used for find the best match in the previous frame to the said block.

In the motion estimation procedure, the search region in the previously transmitted frame is generally centered on the same spatial location as the target MB in the current frame, except possibly for the border MBs. For the border MBs, the borders of the previously coded frame may be extended to accommodate this centering of the MB within the search region. The horizontal portion of search region is extended in both left and right directions. Similarly the vertical portion of the search region is extended in both up and down directions. As an example if the horizontal search is extended by 32 pixels to the left, and 31 pixels to the right, the horizontal search region is denoted by [−32, 31]. Similarly, the vertical portion of the search region might extent in both direction by −16 pixels (16 pixels to the top of the target MB) and +15 pixels (15 pixels to the bottom of MB). This is denoted by [−16, 15]. This is depicted in FIG. 2. The search region might exceed the actual frame boundaries as described, for example, in MPEG-4. Put together, the search region defines a rectangular region defined by the parameters for horizontal and vertical values. For the example the above search region is defined by [−32, 31]×[−16, 15]. The search region is carefully chosen to match the computational capability of the encoder along with the required power consumption while matching the type of video content.

The criterion used to find the best match is generally sum of absolute difference (SAD) values of target MB and the MB size region, selected in the previously coded region. More specifically, the sum of absolute pixel by pixel difference for all the pixels in the target MB and a 16×16 area in the said search area in the previously transmitted frame is summed to arrive at the SAD value. Note that this search might be conducted for every possible 16×16 area of the search area for previously transmitted frame which is the so-called the exhaustive search. In the example given above, there are 64×32=2048 different possible 16×16 matching points. The area for the search region of [−32,31]×[16×15] is (5×16)×(3×16)=3840 pixels. As another example, if the search area was [−32,31]×[−32,31], then there will be 64×64=4096 different possible 16×16 matching points and the search area will be (5×16)×(5×16)=6,400 pixels.

Those skilled in the art realize that this search regions are only examples of what a search region looks like and the system designer is free to choose values for both horizontal and vertical search regions.

The 16×16 area in the search region with the lowest value of SAD is then selected as the best match. The resulting reference pointers indicating the horizontal and vertical displacement (horizontal and vertical offset) of the best match with respect to the target MB, called the motion vectors (MV) are thus obtained. The MVs, therefore, indicate the matching position in the previously transmitted frame relative to the current position of the target MB.

There are also other means for selecting the best match, such as the size of motion vectors, or measuring the required bit rate for transmission of MB and MVs, etc.

The motion estimation (ME) contains the most intensive computational complexity and the most memory requirements of the video compression system. It also consumes a large amount of energy or power for data movement in the system. The data movement part, described later, is caused by bringing the required search region into local memory for each ME search of each target MB.

In digital signal processor (DSP) or application specific integrated circuits (ASIC) or system on chip (SOC) implementations of ME, the previous frame is too big to be put into local memory. The local memory is generally small due to cost issues, but provides fast access to the processor for computation. It is important to have the search region in the local memory for fast execution of the calculation of the said SAD calculation. The frame which is generally big in size (one frame is of size 720×480 pixels for standard television or 1920×1080 pixels for HDTV) is, as a result, stored in remote memory such as SDRAM or hard disk, and the required search region for each MB is then brought into the local memory for calculations. As shown before the search region itself, contains the large amount of data. This search region, however, has to be updated for each MB for which ME is conducted.

The conventional approach used today is to completely remove the search region from the local memory after each calculation of ME for each MB and bring into memory the required search region for the new MB each time. As calculated earlier, this means 3840 or 2304 pixels, for [−32×31]×[−16,15] and [−16,15][−16×15] search regions, respectively, of old search area needs to be removed from the local memory and be replaced by the new search area of the same size which is transferred from the remote memory (SDRAM) to local memory. This has to be done for each target MB of each frame. As an example, each HDTV frame contains (1920/16)×(1080/16)=8100 MBs. This approach creates two issues. First, the movement of the data consumes a large amount of energy resulting in power consumption and heat generation for the system. This power consumption creates an important problem for battery operated systems with power consumption limitations such as mobile devices. In addition, this approach consumes a large amount of data cycles resulting in coding delay and requiring fast bus speeds to transfer data, even though a dedicated engine, called direct memory access (DMA) device, might be used for this purpose.

To better describe this innovation, let us first discuss the memory structure. It is important to understand that the memory, local or remote, is simply a sequential collection of storage elements with each element used to save the value of one element or pixel. As an example, the two dimensional data which is generally shown in two dimensional format for the purpose of illustration, are stored in memory as one dimensional data. More specifically, each row of elements or pixels in the two dimensional data is followed by next row in a raster scan fashion. An example of a search region of [−32, 31]×[−16,15] is depicted in FIG. 3. The fashion in which this area may be stored in memory is that, the storage of each row is followed by the storage of the next lower row, and the last pixel element of each row 305 (rightmost pixel in a row in the FIG. 3) is adjacent to the first element (leftmost pixel a row in the FIG. 3) of the next lower row 307, for all the pixels in this search region. The two-dimensional depiction is used for ease of understanding and realization. In a cyclic memory structure, the last element of the memory, depicted by letter “l” 303 in FIG. 3 is followed by the first element of the memory, depicted by letter “f” 302 in FIG. 3, hence creating a cycle. The co-sited MB in the search region corresponding to the target MB of the current frame is also depicted here 304.

### SUMMARY OF INVENTION

Accordingly, the present invention is directed to a method that substantially obviates one or more of the problems due to limitations, shortcomings, and disadvantages of the related art.

One advantage of the invention is greater efficiency in reducing the data movement required for accessing the search region from the remote storage for conducting the motion estimation for horizontally or vertically adjacent macroblocks (MBs).

Another advantage of the invention is the reduction of data cycles necessary to access the search region from the remote storage for conducting the motion estimation for horizontally or vertically adjacent MBs.

A third advantage of the invention is that it allows slower and less expensive communication buses to accomplish the same task as the more expensive higher speed communication buses which need to be used for the systems not taking advantage of the current invention.

To achieve these and other advantages, one aspect of the invention includes a method of proper replacement of only a portion of the data in search region currently in the local memory while keeping the rest of the data in the local memory for search region intact, for the next target MB which is horizontally adjacent and to the right of the current target MB.

Another aspect of the invention includes a method for using the search region for ME calculation of the two vertically adjacent MBs and proceeding with compression of each of the said MBs to create bitstreams for each of MBs to be appropriately appended after the row of MBs are compressed.

Another aspect of the invention includes a method for using the search region for ME calculation of the two vertically adjacent MBs and proceeding with storage of the obtained motion vectors and residual components for the lower MB and retrieving them at the correct time for further compression.

There are no previous methods for reducing the data access for horizontally adjacent MBs.

In case of vertically adjacent MBs, previous methods have shortcoming in describing how the vertically adjacent MBs are to be compressed, in U.S. Pat. No. 7,496,736 to Haghighi, after ME of each MB is calculated which is a fundamental issue for compressing of MBs. A complete description is provided in this disclosure on how vertically adjacent MBs are to compressed.

Additional aspects of the invention are disclosed and defined by the appended claims. It is to be understood that both the foregoing general description and the following detailed description are exemplary and explanatory and are intended to provide further explanation of the invention as claimed.

### BRIEF DESCRIPTION OF DRAWINGS

The accompanying drawings illustrate a preferred embodiment of the invention. The drawings are incorporated in and constitute a part of this specification. In the drawings,

FIG. 1 is a block diagram of a video compression based on MPEG-1;

FIG. 2 is the search region [−32, 31]×[−16,15] in the previous frame and the target MB and next target MB in the current frame;

FIG. 3 is the pixels for search region [−32, 31]×[−16×15] in the previous frame for a target MB and illustrates the co-sited MB is the search region.

FIG. 4 is the pixels search region for the previous target MB which will be left intact (o) and the pixels that are no longer needed (p) for the search region for the new MB;

FIG. 5 is the pixels for search region for the both previous target MB and the new target MB;

FIG. 6 indicates the starting point in the search region for the previous target MB;

FIG. 7 depicts the replaced pixels (n) for the new target MB in the old search region with the new starting point of the search region for the new target MB along with un-used left-over pixels for search region for pervious MB;

FIG. 8 depicts the alternative viewing of FIG. 7, and demonstrating the search region for new target MB more clearly; and

FIG. 9 depicts the search region pixels for the top MB and the search region for the vertically adjacent bottom MB.

### DETAILED DESCRIPTION

### Introduction

Methods consistent with the invention avoid the inefficiencies of the prior art for acquiring motion estimation search area, by significantly reducing the amount of the data needed to be moved for creation of motion estimation search area process. Following the procedure described in this invention, not only the power consumption for the system is reduced due to decrease in the data movement, but also the cycle count for performing the data movement and therefore the cycle count for video compression is reduced since fewer cycles are required to create the motion estimation search area. Additionally, slower speed, and therefore, less expensive communication buses may be used to accomplish the same task that expensive, higher speed, communication buses achieve, when not using the current invention. The method described here is applicable to all video coding standards such as MPEG-1, MPEG-2, MPEG-4, H.261, H.263, H.264, VC-1, VP8 in addition to any other video compression system employing motion estimation. This method is also applicable to any search mechanism that uses a template matching scheme.

To achieve the improvement in reduction of data movement, an implementation consistent with the invention provides a means for replacing a small portion of the previous search region needed for the old target MB with the new search area of (almost) the same small size. The newly formed search area is the area needed to perform the search for the new target MB.

In the preferred implementation, the unusable portion of the search region of the Old target MB for the new target MB, is replaced by the required search region for the new target MB which is not part of common search areas for the new target MB and the old target MB. The said area will be added to the common search area between the old target MB and the new target MB to construct the full search region for the new target MB. The size of this new added area is much smaller that the entire search area required for ME, resulting in significant saving in the data transfer.

In another method, a cyclic structure of the memory maybe used to implement the said procedure for replacement of the portion of the memory for the new target MB.

In yet another method, the mechanism for performing motion estimation and compression for vertically adjacent MBs is provided.

### Video Compression System

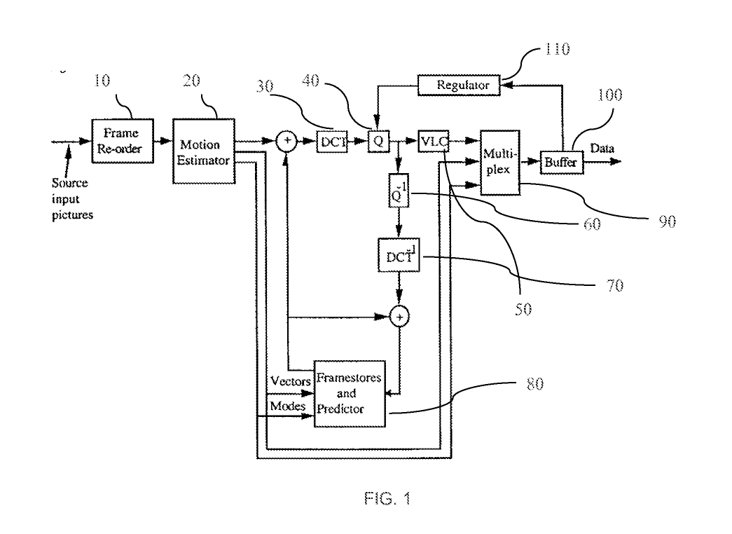

FIG. 1 illustrates a video compression system based on MPEG-1 developed by International Standards Organization (ISO) video coding standard. We chose MPEG-1 for illustration purposes since it is the first international standard in MPEG arena and all other ISO and International Telecommunication Union (ITU) video coding standards such as MPEG-2, MPEG-4, H.261, H.263, and H.264 follow the same principles as far as the motion estimation is concerned. System in FIG. 1 comprises of a frame reordering 10, a motion estimator 20, a discrete cosine transform (DCT) as block transform operator 30, a quantizer (Q) 40, a variable length encoder (VLC) 50, an inverse quantizer (Q⁻¹) 60, an inverse discrete cosine transform (DCT⁻¹) 70, a frame-store and predictor 80, a multiplexer 90, a buffer 100, and a regulator 110. The frame reordering component reorders the input video for proper coding order. The operation for each frame of video follows on MB by MB basis from left to right and starting from the top left hand corner of the frame and continues on, MB row by MB row basis, and ending at the bottom right hand corner of the frame. The motion estimator for P and B frames accesses the previously coded frames from the frame-store and provides the motion estimation for the MB. The motion estimator is not used for 1 frames. The output of the motion estimator which are used for P and B frames are motion vectors (MV), the selection mode indicates if motion estimation is used or not, and MB residuals which is the difference between the target MB and the chosen area in the previously transmitted frame, are now ready for compression. The said original or residual output for MB is then transformed using DCT, quantized using Q, variable length encoded using VLC, and is multiplexed with the MV data and selection modes and send to the buffer for storage or transmission. The buffer is used to regulate the output rate, as for example change the variable nature of video compression output to a fixed rate output which might be required for storage or transmission. The status of the buffer is then used by regulator to determine the value of quantizer (Q) to be used for subsequent MB data in order to sustain the required bit rate output of the system.

### Method of Operation

### Horizontal MBs

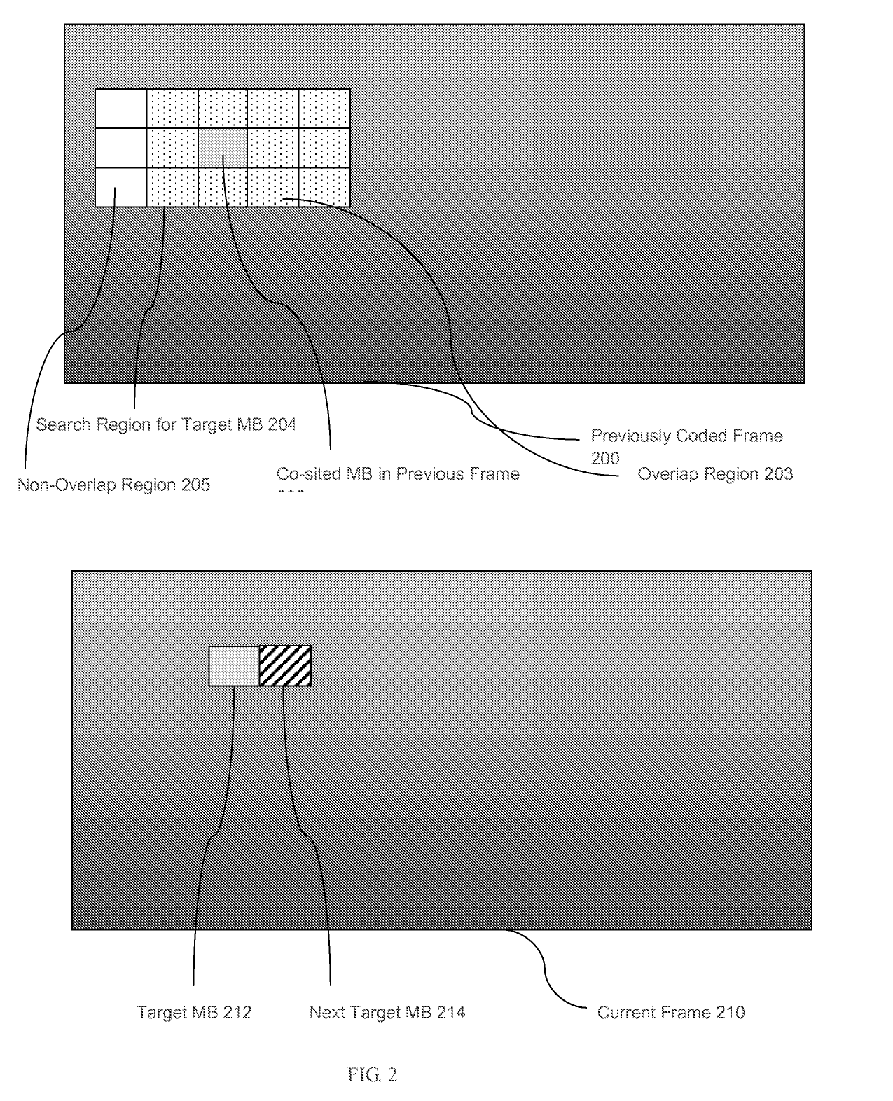

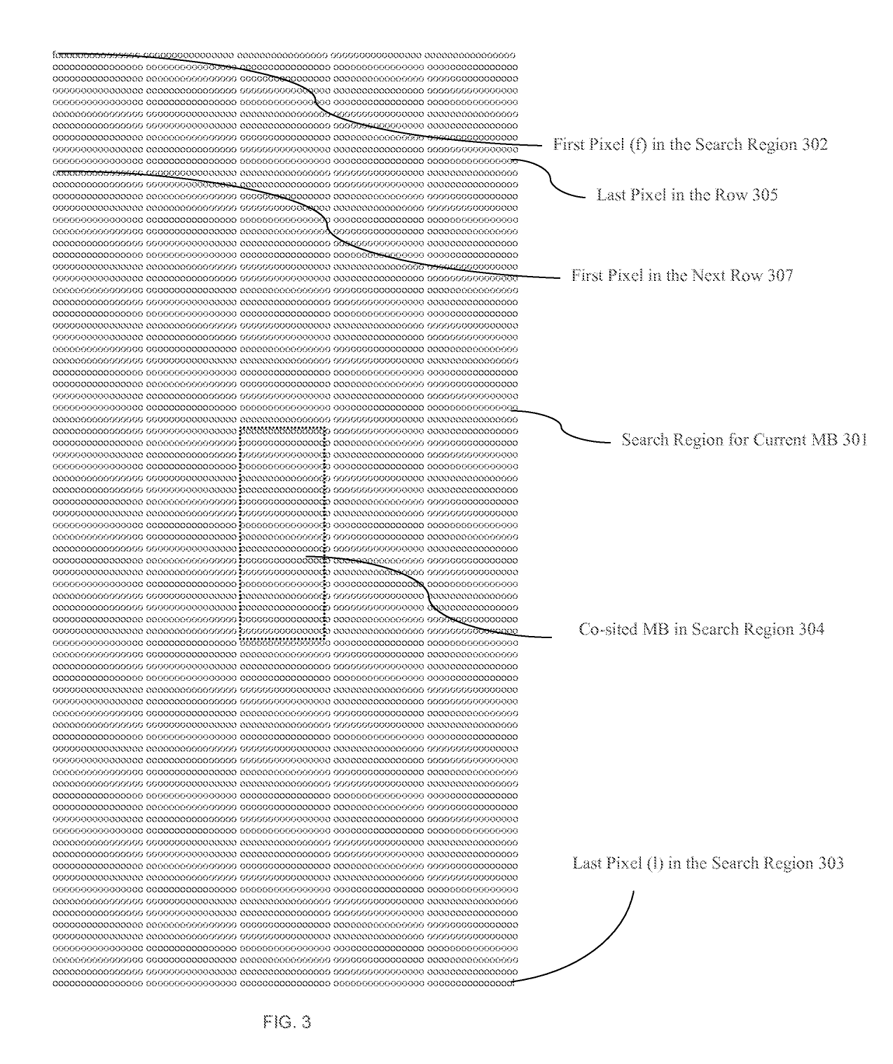

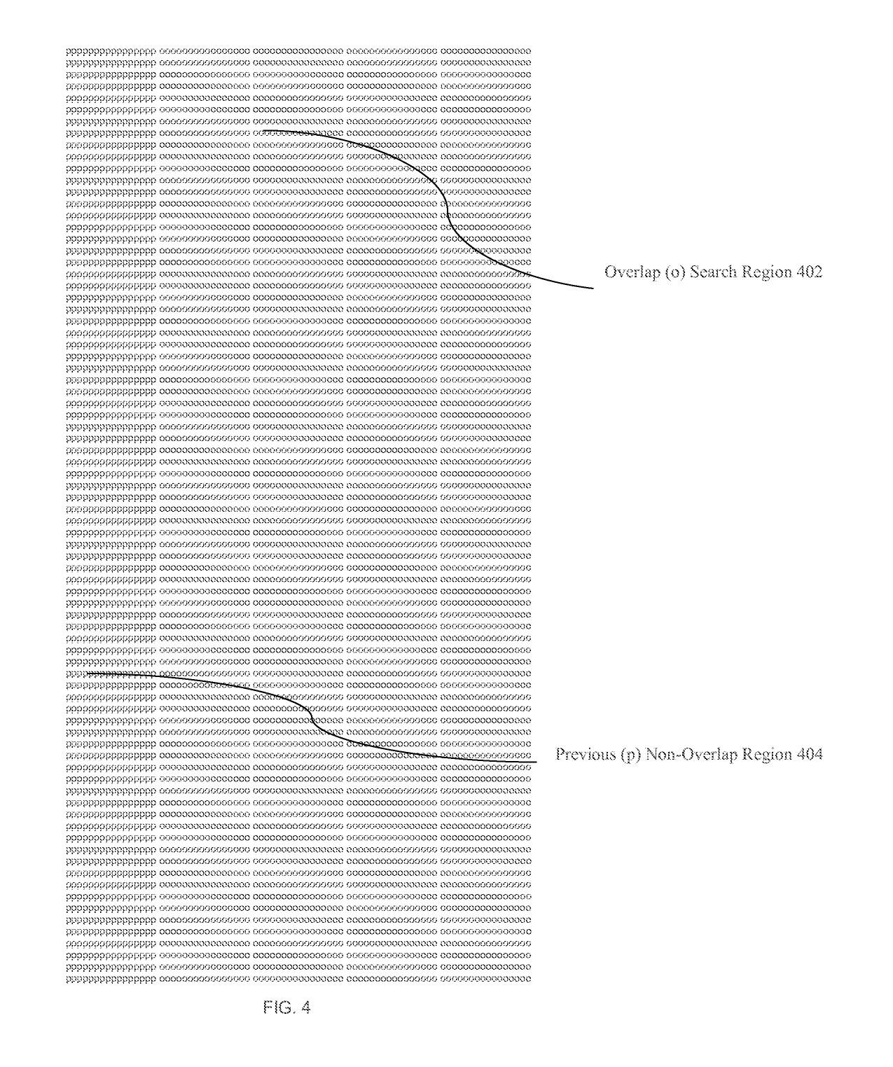

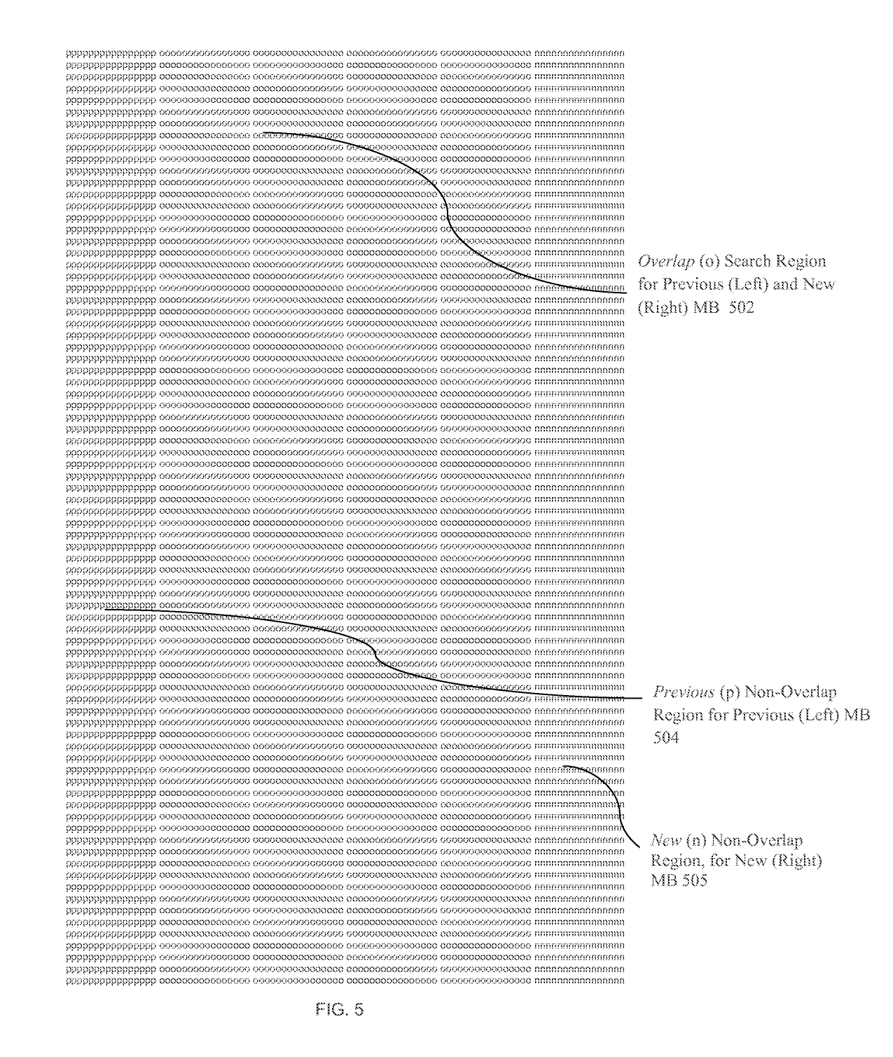

Systems consistent with the present invention replace the movement of the search region from the remote storage to local memory for each target MB by the more efficient search region update. The improvement results in fewer pixels to be moved which also decreases the clock cycles required for the movement for the new target MB (new MB). It also allows use of slower, and therefore, less expensive communication buses to be used in place of faster, more expensive, communication buses. FIG. 2 shows the search region 204 centered around the co-sited MB 202 in the previously coded frame 200, for the target MB (old MB) 212 in the current frame 210 to be compressed. It also shows the overlap search region 203, between the target MB 212 and the next target MB 214 (new MB) in the current frame, in addition to the non-overlap region 205 between the two said MBs. FIG. 3 shows the search region 301 of size [−32,31]×[−16,15] for the target MB in pixel format. FIG. 4 shows the overlap search region, indicated by “o”, between two horizontally adjacent MBs (the MB to be compressed and the next MB to be compressed in the current frame). It also shows the non-overlap search region 404, indicated by “p”, between these two MBs which is part of search region for the current MB and not needed for the next horizontally adjacent MB. FIG. 5 shows the overlap region between the two horizontally adjacent MBs 502 indicated by “o”, the non-overlap region belonging to the left MB 504 is indicated by “p”, and the non-overlap region belonging to the right MB 505 indicated by “n”. The pixels indicated by “p” are no longer needed for search region of the new horizontally adjacent MB. The pixels indicated by “n” are needed to be accessed from the remote location such as the SDRAM to create the search region for the new horizontally adjacent MB, as can be observed when FIG. 4 and FIG. 5 are compared.

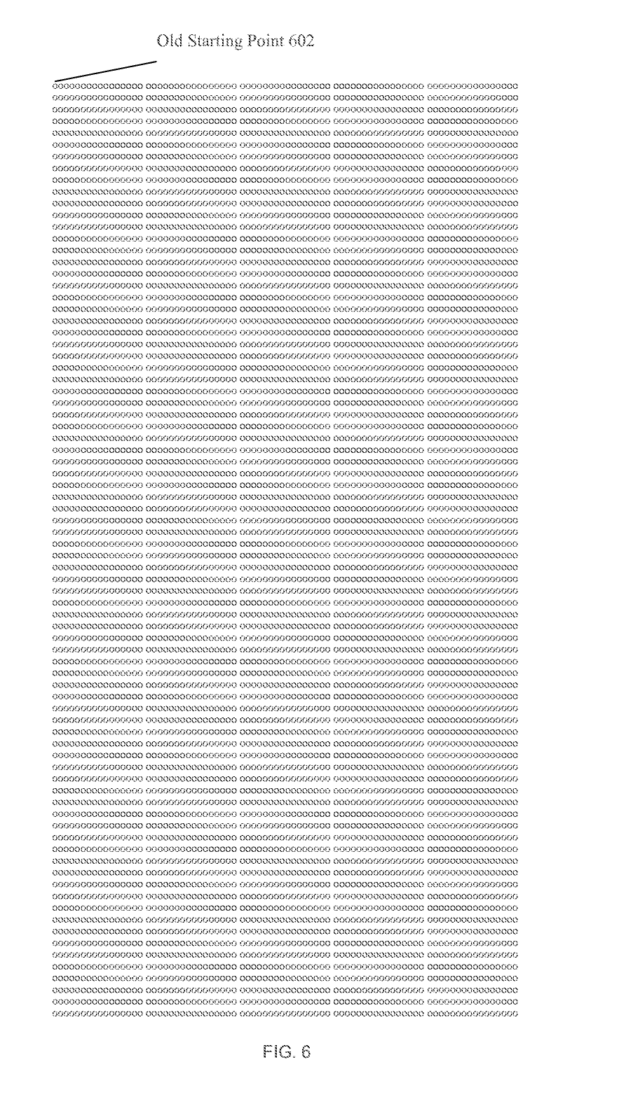

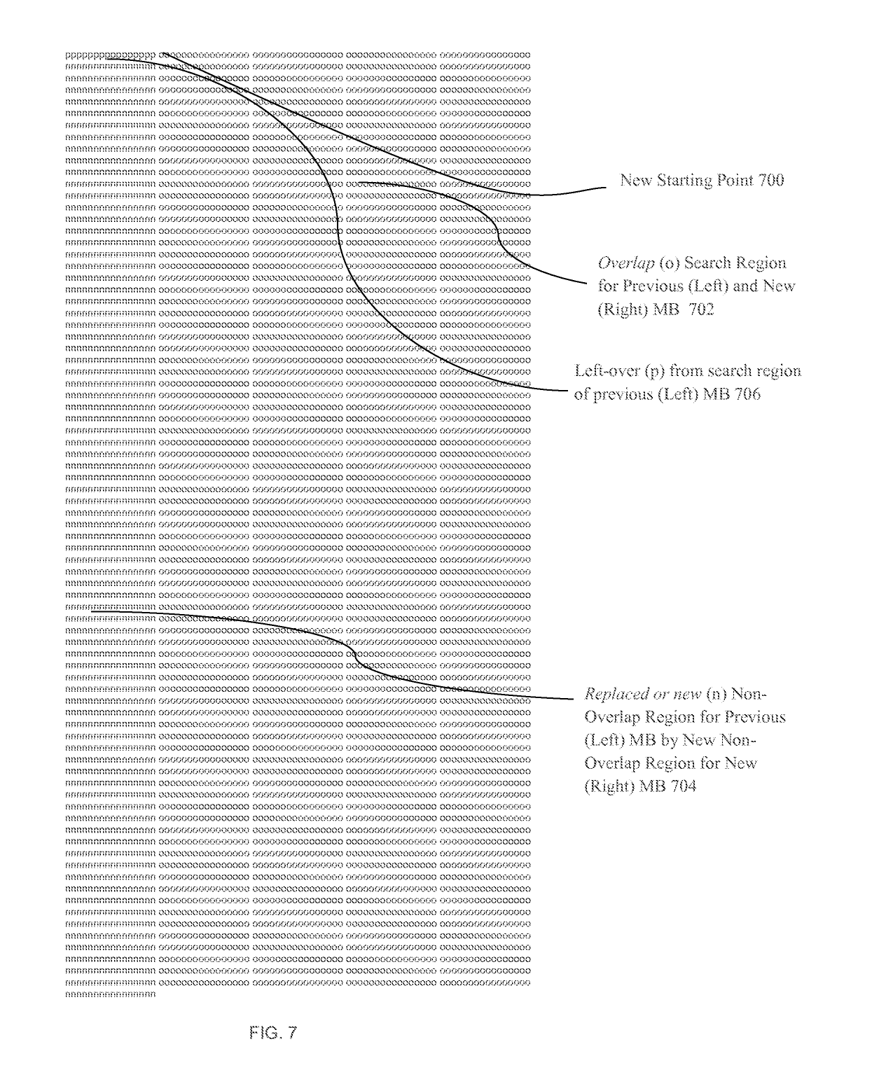

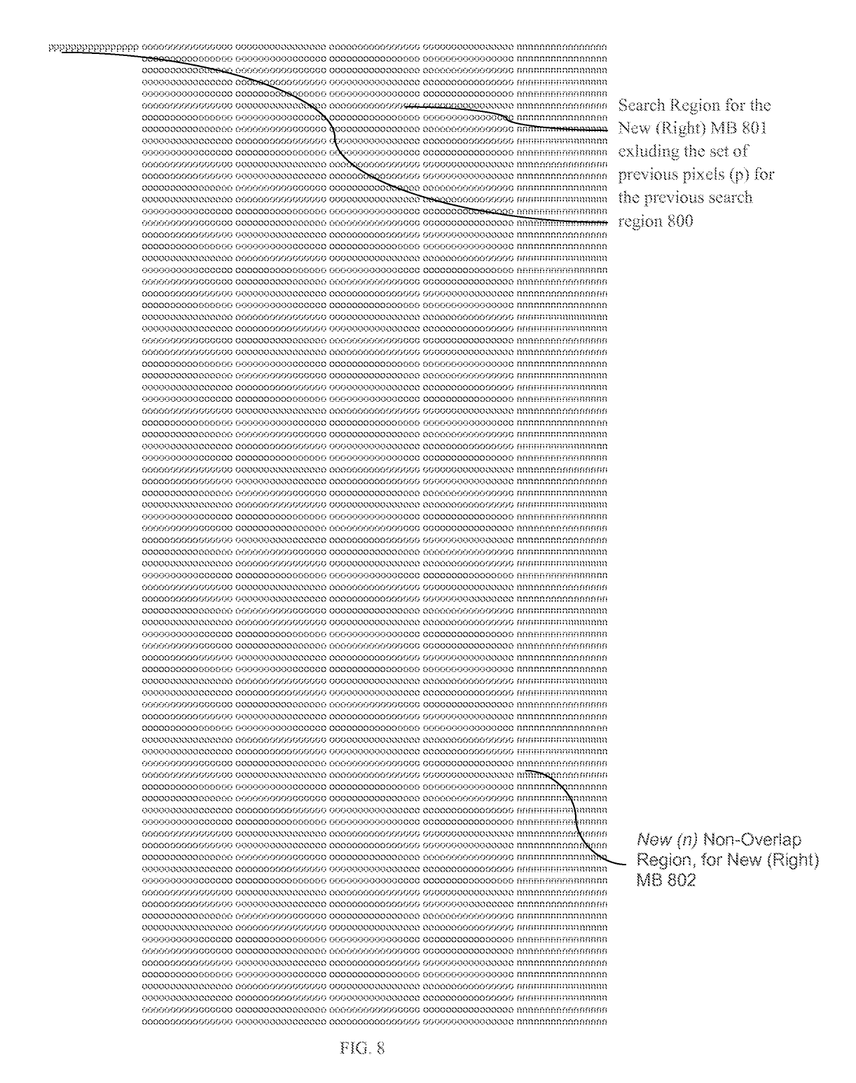

As described before since the data in the memory are structured in consecutive pixel elements and row by row, it means that the last pixel in each row of pixels is followed by the first pixel of the next row of pixels. The efficiency of this invention resides in replacing the left hand columns of the search region of width MB 404 (the pixels depicted as “p” in FIG. 4), which is the old non-overlap region between two consecutive MBs, with pixels depicted as “n” 505 in FIG. 5 which are the new non-overlap region between two consecutive (old and new) target MBs. This replacement of “p” pixel by “n” pixels, is done by starting at the second row of search region for the previous MB as shown in FIG. 7. Now we can obtain the search region for the new MB by simply changing the old starting point 602 shown in FIG. 6 to a new starting point 701 shown in FIG. 7. Again, since the pixels are stored in consecutive memory location, the structure in FIG. 7 may be viewed as depicted in FIG. 8 which is the correct motion estimation region for the new MB, excluding the “p” pixels. More precisely we observe that the end of the first row of overlap region is now followed by the first row of the said new non-overlap area. Similarly the second row of overlap region is followed by the second row of said new non-overlap area placed in the beginning third row. This process continues so that the last row of overlap region is followed by last row of said non-overlap area and placed in the (last+1)th row.

The said memory structure is shown in FIG. 8 shows the exact same structure as FIG. 3 but the starting point is simply changed to represent the starting point for the search region for the said new target MB. It is clear that this represent the search area for the next horizontally adjacent target MB. The efficiency stems from the fact that we have only replaced one column of MBs to create the search region for the new target MB as opposed to the conventional systems requiring full search region replacement. This results in a factor of 3 to 5 efficiency, depending on the width of the search region being 3 or 5 times the size of MB, in data movement. It also provide factor of 3 to 5 reduction in the required data cycles. Note that these factors of efficiency depend on the width of search region but is independent of the frame type such as P-frame or B-frame. That is the same factor in efficiency is achieved for either of P-frames or B-frames.

### Vertical MBs

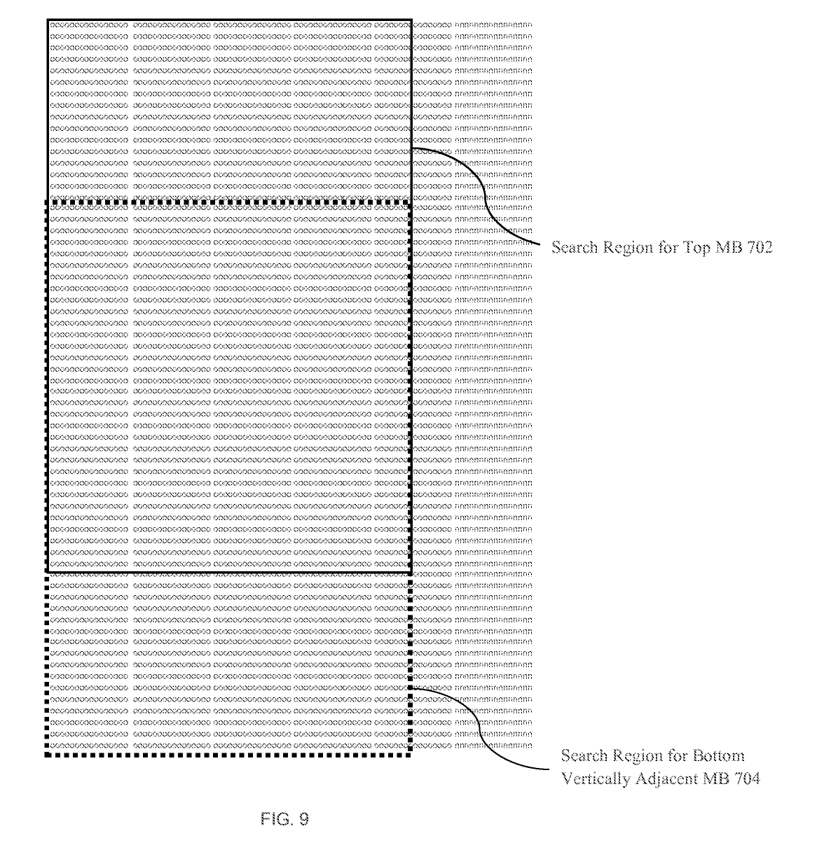

Systems consistent with the present invention also provide motion estimation (ME) for two or more vertically adjacent MBs. The search area that is transferred from the remote storage into local memory is large enough to satisfy the search region requirements for two or more vertically adjacent target MBs as shown in FIG. 9 for two vertically adjacent MBs.

Based on the first embodiment of present invention for vertical MBs, the motion estimation is conducted for the top most MB in this configuration. This process is then followed by the rest of compression process for the said MB as described earlier for compression of MBs consisting of said process of block transformation, said quantization and said variable-length coding resulting in a bitstream representing the MB which is then stored in memory. The motion estimation area stays intact in memory for this entire process.

The process of motion estimation is then performed on the new target MB just vertically below the previous MB without any need for remote memory access to establish the motion estimation region. Note that the ME for the lower MB may be conducted right after the ME is conducted for upper MB.

The result of ME for vertically lower MB, which are the motion vectors and the residual MB are stored back in the remote memory. This information will be accessed after the complete or partial compression of current row of MBs. The MB residuals may need to be stored in remote memory if the size of residuals for entire or partial row of MBs is too large to fit in the local memory. The values of motion vectors could be either stored in the local or remote memory since those values for the entire row of MBs are not very large.

The said process continues for the rest of vertically adjacent MBs until the entire row of vertical MBs are processed.

The second embodiment consists of the exact process for the upper target MB to be conducted for the lower MBs. More specifically, after the upper target MB is compressed, the lower target MB is compressed using the said process and the generated bitstream is stored in a different memory location as the previous vertically upper adjacent MB. This bitstream is then ready to be accessed when the entire row of upper MBs are compressed. The process of motion estimation and compression is then continued for the subsequent vertical MBs adjacent to the previous vertical MBs taking advantage of the search region replacement described in the horizontal MBs section. This process is continued until the entire row of vertical MBs are processed.

Following the above said embodiment, if the first preferred embodiment is used for storage of the MVs and residual MBs, these data are then retrieved and compressed to create the bitstream for lower vertical MBs.

If the second said embodiment is used, the bitstream generated by lower row of vertical MBs which was stored in the said memory, is then appended to the bitstream generated by the upper row of vertical MBs creating bitstream for two vertically adjacent row of MBs.

The above process is continued in similar fashion until the bitstream is generated for the entire frame.

The combined effect of using both horizontal search area update and vertical scheme provides a significant advantage over the conventional schemes.

### Illustration of Operation

### Horizontal MBs.

We first describe the invention for horizontal MBs. In motion estimation part of a video compression system, the search area for a target MB is fetched from the remote memory into the local memory. An example of this search area is shown in FIG. 3 for search region of [−32, 31]×[−16, 15]. Also shown in this Fig. is the location of the target MB of current frame, in reference to the search region of the previous frame. As shown in FIG. 3, the first pixel of this region is denoted by “f” and the last pixel is denoted by “l”.

After completing the search, we need to conduct the search for the next horizontally adjacent MB. For this process, we need to load the local memory with the appropriate ME region. The conventional approach was to completely remove the search region from the local memory and load the new search region. For the size of the search area used in this example, it means that it is required to load an area of [−32, 31]×[−16,15] into the local memory which corresponds to 3840 pixels.

FIG. 5 illustrate the new pixels “n” required to be fetched for the search area of new MB and also shows the no longer needed area belonging to the search area of previous MB “p”.

Using the innovative approach described in this disclosure, we would only need to fetch 16×[−16,15] pixels or 512 pixels resulting to a savings factor of (5×16)×(3×16)/(3×16×16)=5. This is accomplished by replacing the column of width 16 by height of 48 of leftmost area of the previous search region, depicted by “p” in FIG. 4, by the new data from the remote memory by skipping the first row and starting at the second row. The replaced area corresponds to non-overlap area belonging to the previous MB (old non-overlap) and is no longer required for the new search area. The newly fetched area corresponds to the non-overlap area belonging to the new MB and not required for the old MB. The newly fetched area replaces the old non-overlap starting at the second row and resulting in additional row of size 16, with 16 being the size of MB, at the end of the search area as shown in FIG. 7.

Given the newly formed search area, if we advance the starting point of the search area by 16 pixels to the right, which is the size of MB, we obtain the search area for the new MB as shown in FIG. 7 and better depicted in FIG. 8.

If we use a cyclic structure for the memory, the additional row of size 16 (at the very end of the search area) will be replacing the top 16 pixels belonging to first row of the old search region (p). This cyclic structure removes the need to additional storage area of 16 pixels. Note that local memory is large enough to accommodate the extra storage requirement of 16 pixels.

The procedure described above can be repeated again and again until the motion estimation for the entire row of MBs is performed. The process is then restarted for the next lower MBs, for which the entire ME region need to be accessed, and repeated until the entire row of MBs covering the entire frame is processed. In case the cyclic structure is not used, the additional requirements for storage of 16 pixels for each time that this procedure is used might cause the local memory to be exhausted. In this unlikely situation, it is required that the memory be flushed and the entire process start with complete retrieval of search region for the current MB followed by the said procedure for the rest of the MBs in the row.

Vertical MBs

We now focus on the invention as applied to vertical MBs. The search area for the top MB and bottom MB is shown in FIG. 9. We observe that there is large overlap between these two search regions. It is, therefore, advantageous to do the motion estimation for both MBs while the data is in the local memory. Following this procedure, we can obtain a factor of 3 in pixel transfer when the vertical search region is [−16, 15]. This factor is higher for bigger vertical search regions. Those skillful in the art realize that this saving is based on the size of the search region used as example in here, and bigger search regions result in more savings. In addition, more than two vertically adjacent MBs may be used resulting in even more savings.

It is easy to see that motion estimation can be performed for both top and bottom MBs and this has been described in earlier disclosures in U.S. Pat. No. 7,496,736 to Haghighi. The issue, however, is what is to be done after the motion estimation is performed

We provide two preferred embodiment for this.

The first embodiment is to continue the rest of compression process for the top MB. This includes the block transform, quantization, variable-length coding for the top MB. The result of motion estimation for the lower MB which consists of the motion vectors and residual MB are stored in the memory. We continue the said process for the rest of top MBs and lower MBs for this two row of MBs. The top MBs will be compressed while the results of ME for lower MBs are stored. After the top row of MBs are processed, the results for the lower MBs are retrieved and compressed starting at the leftmost lower MB.

In the second embodiment both top of lower MBs are compressed based on the video compression procedure. The bitstream generated for the lower MBs are stored into the memory and appended consecutively as the following MBs are processed. Similar procedure is used for lower MBs. After the compression of top row of MBs, the bitstream for upper MBs will be appended by bitstream for the lower MBs creating the bitstream for two row of MBs.

The said process will be continued for the next two vertical MBs and so on until the entire frame is processed. In the movement in horizontal direction for the vertical MBs, we can utilize the said approach for horizontal MBs to reduce the amount of movement.

Note that the only limitation on the number of vertical MBs that is to be processed in this fashion is the size of the local memory. Those familiar with the art realize the using more vertical MBs will result in more savings in terms of pixel transfer. Therefore, the process described here for two vertical MBs may be applied to any number (three or more) of vertical MBs resulting in more significant reduction in pixel movements.

When both horizontal and vertical techniques introduced here are used for horizontal MBs and vertical MBs, the saving factor in data movement becomes the product of savings factors of each of the horizontal and vertical techniques.

### CONCLUSION

Systems consistent with the present invention provide for more efficient access to the search area used for motion estimation. These systems provide for greater efficiency by replacing only the non-overlap search region between the old MB and new horizontally adjacent MB, by new non-overlap search region which is to be used by the new MB. This keeps the overlap region between two horizontally adjacent MBs in the local memory intact, eliminating the need to retrieve the said region again, from the remote memory.

The acquisition of motion estimation search area in the said case, where horizontal adjacency is used, can be improved by at least factors of 3 to 5 for the examples described in this disclosure and can be larger based on the width of horizontal search.

The invention also provides for more efficient use of the search region by two or more vertically adjacent MBs. In one embodiment, the process of motion estimation for each of the said MBs is followed immediately by compression process for each of MBs, creating a bitstream for each MB and storing the result in memory eliminates the need to access the result of motion estimation for each MB when the compression is not conducted immediately. In another embodiment, the result of ME is stored in memory to be retrieved at the proper time later in the compression process.

The acquisition of motion estimation search area in the said case, where vertical adjacency is used, improves the said acquisition process by at least factors of 3 to 5 for the examples described in this disclosure and can be larger based on the height of the vertical search.

When both horizontal adjacency and vertical adjacency is used together, the acquisition of motion estimation search area can be improved by the product of efficiencies in each case resulting to at least factors of 9 to 25 savings depending on the width and height of search area. This factor increases as the search areas are increased in either horizontal or vertical directions.

The above examples and illustrations of the advantages of using methods consistent with the present invention over the related art are not meant to limit application of the invention to cited examples. Indeed, as explained in the preceding sections, the methods consistent with present invention may use not only macroblocks but may also use multiple macroblocks, blocks or sub-blocks or objects in both motion estimation or pattern matching systems. Furthermore, the number of vertical MBs and horizontal MBs cited here are to be used only as examples and alternative embodiment may be used for this purpose.

What is claimed is:

1. A method for construction of motion estimation area for consecutive horizontal macroblocks (MBs) in which in the previous frame, overlapped search area of new target MB with the search area of old target MB, is not removed.

2. A method for construction of motion estimation area comprising of steps:
replacing the non-overlapped search area between the new MB and old MB belonging to the old motion estimation area, by the non-overlapped search area between the new MB and old MB belonging to the new motion estimation area;
keeping the overlapped-search area between the old MB and new MB intact.

3. The technique of claim 2 in which a cyclic memory structure is used.

4. A method for construction of motion estimation area comprising of steps:
partially replacing the non-overlapped search area between the new MB and old MB belonging to the old motion estimation area, by the non-overlapped search area between the new MB and old MB belonging to the new motion estimation area;
keeping the overlapped-search area between the old MB and new MB intact.

5. A method for construction of motion estimation area for consecutive horizontal MBs in which the non-overlapped search area, between the old MB and new MB, belonging to the new MB partially replaces the non-overlapped search area, between the old MB and new MB, belonging to the old MB.

6. The technique of claim 5 in which a cyclic memory structure is used.

7. A method for construction of motion estimation area for consecutive horizontal macroblocks (MBs) in which the non-overlapped search area, between the old MB and new MB, belonging to new MB completely replaces the non-overlapped search area, between the old MB and new MB, belonging to the old MB in which a cyclic memory structure is used.

8. A method for construction of motion estimation area for consecutive horizontal MBs in which when transitioning from the motion estimation area of one target MB to the motion estimation area of next target MB, the starting point in the search area is changed.

9. A method for construction of motion estimation area for vertical MBs comprising of steps:
using the existing motion estimation area in the memory;
estimating the motion for top and bottom MBs;
storing the ME results comprising of motion vectors and MB residuals in memory;
retrieving the ME results in proper time for further processing.

10. A method for construction of motion estimation area for vertical MBs comprising of steps:
using the existing motion estimation area in the memory;
estimating the motion for top and bottom MBs;
continuing with the rest of compression process for each MB and creating the resulting bitstreams;
storing the bitstreams to be retrieved in proper time for further processing.

11. A technique for which the motion estimation search area is used for multiple target MBs.

12. A method for construction of pattern matching area comprising of steps:
replacing the non-overlapped pattern matching area between the new target pattern and old target pattern belonging to the old pattern matching area, by the non-overlapped pattern matching area between the new target pattern and old target pattern belonging to the new pattern matching area;
keeping the overlapped-search area between the old target pattern and new target pattern intact.

13. The technique of claim 12 in which a cyclic memory structure is used.

14. A method for construction pattern matching area comprising of steps:
partially replacing the non-overlapped pattern matching area between the new target pattern and old target pattern belonging to the old pattern matching area, by the non-overlapped pattern matching area between the new target pattern and old target pattern belonging to the new pattern matching area;
keeping the overlapped-search area between the old target pattern and new target pattern intact.

15. The technique of claim 14 in which a cyclic memory structure is used.

16. A method for pattern matching of consecutive horizontal patterns in which overlapped search area of previous frame for new target pattern with the search area of old target pattern, is not removed.

17. A method for pattern matching of consecutive horizontal patterns in which the non-overlapped search area of new pattern completely replaces the non-overlapped search area of the old pattern and a cyclic memory structure is used.

18. A method for pattern matching of consecutive horizontal patterns in which when transitioning from one target pattern to the next target pattern, the starting point in the search area is changed.

19. A technique for which a search area is used for multiple target patterns.
